(19) United States
(12) Patent Application Publication
(10) Pub. No.: US 2026/0277956 A1
(43) Pub. Date: Sep. 17, 2026

(54) DATA ANALYSIS SUPPORT SYSTEM, ANALYSIS SUPPORT DEVICE, AND DATA ANALYSIS SUPPORT METHOD

(71) Applicant: NEC Corporation, Tokyo (JP)

(72) Inventor: Takeru ODA, Tokyo (JP)

(73) Assignee: NEC Corporation, Tokyo (JP)

(21) Appl. No.: 19/553,822

(22) Filed: Mar. 2, 2026

(30) Foreign Application Priority Data
Mar. 13, 2025 (JP) 2025-040086

(51) Int. Cl. G06F 16/3329

(52) U.S. Cl. CPC G06F 16/33295

(57) ABSTRACT

A data analysis support system includes site analysis support devices installed at multiple sites and an upper-level analysis support device. The upper-level device receives prompt information including question content, generates site prompt information using a large language model that allows each site device to answer based on the question content, and transmits it to the site devices. Each site device generates site answer information according to the site question content using a large language model based on information in its site database, and transmits the answer to the upper-level device. The upper-level device integrates site answer information from multiple site devices, generates final answer information for the question content from the user terminal, and transmits it to the user terminal. Accordingly, the AI-driven architecture significantly supports rapid decision making while reducing data transfer and protecting data confidentiality.

This application is based upon and claims the benefit of priority from Japanese Patent Application No. 2025-40086, filed on Mar. 13, 2025, the disclosure of which is incorporated herein in its entirety by reference.

### TECHNICAL FIELD

The present disclosure relates to a data analysis support system and the like.

### BACKGROUND ART

JP 7506957 B2 discloses a configuration that receives a prompt from a user and obtains an output by a large language model (LLM) for the prompt.

### SUMMARY

An object of the present disclosure is to provide a data analysis support system and the like that easily suppress an increase in the amount of data communication and ensure data confidentiality.

A data analysis support system according to an aspect of the present disclosure includes a plurality of site analysis support devices, each installed at one of a plurality of sites, and an upper-level analysis support device communicable with each of a plurality of the site analysis support devices, wherein the upper-level analysis support device includes an upper-level processing unit that receives prompt information including question content from a user terminal, generates site prompt information including site question content that allows each of the plurality of the site analysis support devices to answer based on the question content by using a large language model, and transmits the site prompt information generated to the site analysis support device, the site analysis support device includes a site database in which information regarding the corresponding site is accumulated, and a site processing unit that generates site answer information according to the site question content included in the site prompt information received, by using a large language model based on information accumulated in the site database, and transmits the site answer information generated to the upper-level analysis support device, and the upper-level processing unit integrates site answer information from the plurality of the site analysis support devices, generates final answer information for the question content from the user terminal, and transmits the final answer information to the user terminal.

An analysis support device according to an aspect of the present disclosure is an analysis support device communicable with each site analysis support device installed in each of a plurality of sites, the analysis support device including an upper-level processing unit that receives prompt information including question content from a user terminal, generates site prompt information including site question content that allows each of a plurality of the site analysis support devices to answer based on the question content by using a large language model, and transmits the site prompt information generated to the site analysis support device, wherein the upper-level processing unit integrates site answer information generated according to the site question content by the plurality of the site analysis support devices, generates final answer information for the question content from the user terminal, and transmits the final answer information to the user terminal.

A data analysis support method according to an aspect of the present disclosure is a data analysis support method in a data analysis support system including a plurality of site analysis support devices, each installed at one of a plurality of sites, and an upper-level analysis support device communicable with each of a plurality of the site analysis support devices, the data analysis support method including a step of receiving, by the upper-level analysis support device, prompt information including question content from a user terminal, generating site prompt information including site question content that allows each of the plurality of the site analysis support devices to answer based on the question content by using a large language model, and transmitting the site prompt information generated to the site analysis support device, a step of generating, by the site analysis support device, site answer information according to the site question content included in the site prompt information received, by using a large language model based on information accumulated in a site database, and transmitting the site answer information generated to the upper-level analysis support device, and a step of integrating, by the upper-level analysis support device, site answer information from the plurality of the site analysis support devices, generating final answer information for the question content from the user terminal, and transmitting the final answer information to the user terminal.

### BRIEF DESCRIPTION OF THE DRAWINGS

Exemplary features and advantages of the present disclosure will become apparent from the following detailed description when taken with the accompanying drawings in which:

FIG. 1 is a diagram illustrating a configuration of a data analysis support system according to the present disclosure;

FIG. 2 is a diagram illustrating a hardware configuration of a site analysis support device;

FIG. 3 is a diagram illustrating a hardware configuration of an upper-level analysis support device;

FIG. 4 is a flowchart illustrating a procedure of a data analysis support method according to the present disclosure;

FIG. 5 is a diagram illustrating an example of attribute information and address information of a site analysis support device associated with the attribute information extracted from information accumulated in an upper-level database;

FIG. 6 is a diagram illustrating another example of the attribute information and the address information of the site analysis support device associated with the attribute information extracted from the information accumulated in the upper-level database;

FIG. 7 is a diagram illustrating a configuration of a data analysis support system according to the present disclosure;

FIG. 8 is a diagram illustrating a configuration of a data analysis support system according to the present disclosure;

FIG. 9 is a diagram illustrating a procedure of a data analysis support method according to the present disclosure; and

FIG. 10 is a diagram illustrating a procedure of a data analysis support method according to the present disclosure.

### EXAMPLE EMBODIMENT

Hereinafter, modes for implementing a data analysis support system, an analysis support device, a data analysis support method, and a program according to the present disclosure will be described with reference to the accompanying drawings. However, the present disclosure is not limited only to these example embodiments.

### Overall Configuration of Data Analysis Support System

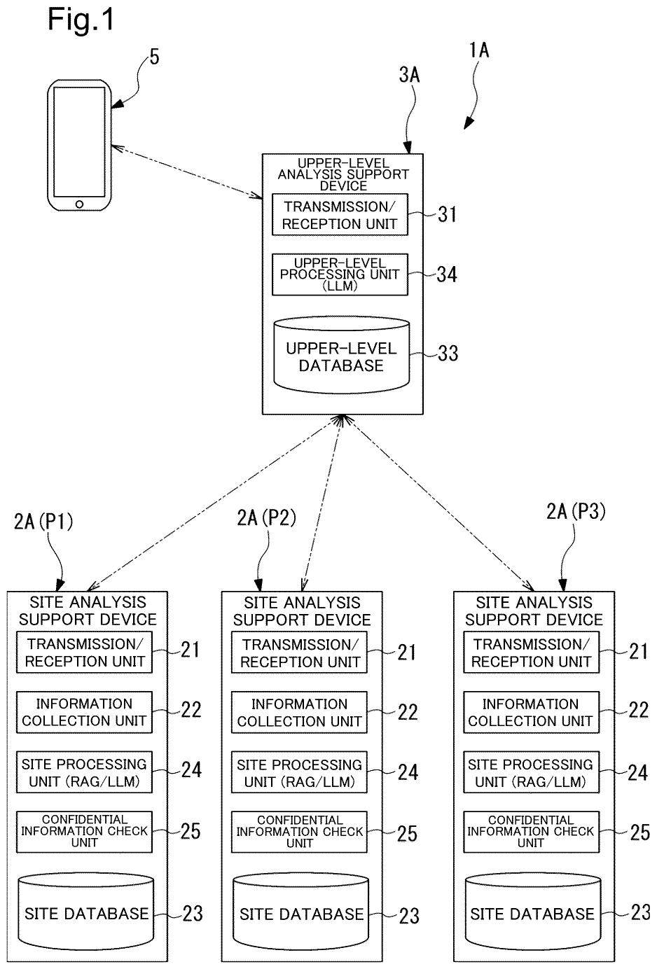

FIG. 1 is a diagram illustrating a configuration of a data analysis support system according to the present disclosure.

As illustrated in FIG. 1, a data analysis support system 1A includes a plurality of site analysis support devices 2A and an upper-level analysis support device (analysis support device) 3A.

The plurality of site analysis support devices 2A is installed in each of the plurality of sites. Examples of the site include factories, stores, buildings, schools, companies, and local governments. Each site analysis support device 2A collects information regarding a site where the site analysis support device 2A is installed. The information collected by each site analysis support device 2A may be any information. For example, there are information output from a device or an apparatus provided in a site, information detected by a sensor or the like, information received via a network, information artificially input from the outside, and the like. Each site analysis support device 2A accumulates the collected information in a site database to be described later.

In the present example embodiment, for example, three site analysis support devices 2A installed in three sites P1 to P3 are provided as the plurality of site analysis support devices 2A.

The upper-level analysis support device 3A can communicate with each of the plurality of site analysis support devices 2A via a network (not illustrated) such as a local area network (LAN), a wide area network (WAN), WiFi, or a public communication network. The upper-level analysis support device 3A may be installed in a place different from the plurality of sites in which the site analysis support device 2A is provided, or may be installed in any site in which the site analysis support device 2A is provided.

Upon receiving an input of a question from the user, the data analysis support system 1A analyzes data accumulated in the plurality of site analysis support devices 2A according to a question content from the user, and outputs an answer to the question content.

The user inputs a question to the data analysis support system 1A using the user terminal 5. Examples of the user terminal 5 include a smartphone, a tablet terminal, and a personal computer.

The prompt information including the question content from the user terminal 5 is received by the upper-level analysis support device 3A via the network. The upper-level analysis support device 3A generates the site prompt information including the site question content for the plurality of site analysis support devices 2A based on the question content included in the prompt information. The upper-level analysis support device 3A transmits the generated site prompt information to each site analysis support device 2A.

The site analysis support device 2A that has received the site prompt information generates site answer information according to the site question content included in the site prompt information. The site analysis support device 2A transmits the generated site answer information to the upper-level analysis support device 3A.

The upper-level analysis support device 3A integrates the site answer information from the plurality of site analysis support devices 2A, generates final answer information for the question content from the user terminal 5, and transmits the final answer information to the user terminal 5.

### Overall Configuration of Site Analysis Support Device

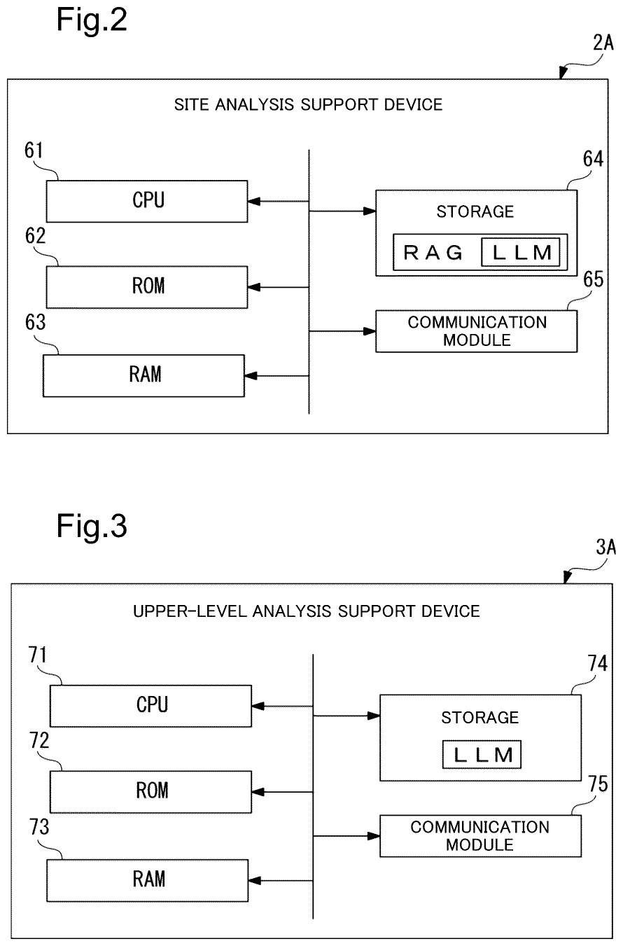

FIG. 2 is a diagram illustrating a hardware configuration of the site analysis support device.

As illustrated in FIG. 2, the site analysis support device 2A is a computer including hardware such as a CPU 61, a ROM 62, a RAM 63, a storage 64 such as a hard disk drive (HDD), and a communication module 65.

In the present example embodiment, the storage 64 of the site analysis support device 2A stores programs of a large language model (LLM) and a retrieval-augmented generation (RAG: search-augmented generation, acquisition-augmented generation).

By the CPU 61 of the site analysis support device 2A executing a program stored in the site analysis support device 2A in advance, as illustrated in FIG. 1, the site analysis support device 2A functionally includes a transmission/reception unit 21, an information collection unit 22, a site database 23, a site processing unit 24, and a confidential information check unit 25.

The transmission/reception unit 21 can communicate with the upper-level analysis support device 3A via a network. The transmission/reception unit 21 receives the site prompt information from the upper-level analysis support device 3A. The transmission/reception unit 21 transmits, to the upper-level analysis support device 3A, site answer information generated in the site processing unit 24 in accordance with the site prompt information.

The information collection unit 22 can receive information regarding a site where the site analysis support device 2A is installed. As described above, the information regarding the site is, for example, information output from a device or an apparatus provided in the site, information detected by a sensor or the like, information received via a network, information artificially input from the outside, or the like.

The site database 23 accumulates the information collected by the information collection unit 22.

Examples of the information accumulated in the site database 23 include the following “attribute information (data attribute name)”.

“Employee information” at each site (specifically, for example, the number of employees, the number of male employees, the number of female employees, the age of each employee, attendance information of each employee, salary, the number of family members, and the like)
“Weather” at each site
“Temperature” at each site
“Humidity” at each site
“Equipment name” used at each site
“Sensor” used at each site
“Energy consumption amount” used in each site (specifically, for example, the amount of electricity used, the amount of gas used, the amount of water used, and the like)
“Security camera image” installed in each site
In a case where the site is, for example, a factory, “product production volume”, “defect rate”, and “sales amount” at each site

Of course, the configuration is not limited to the one exemplified here, and the information accumulated in the site database 23 can be appropriately set.

The site processing unit 24 generates site answer information according to the site question content included in the site prompt information received from the upper-level analysis support device 3A using the large language model and the RAG. The site processing unit 24 generates site answer information according to the site question content by the large language model and the RAG based on the information accumulated in the site database 23. The site processing unit 24 searches for information related to the site question content from the information accumulated in the site database 23 by the RAG. The site processing unit 24 acquires information searched by the RAG from the information accumulated in the site database 23 as information related to the site question content. The site processing unit 24 inputs the site question content and the information related to the site question content acquired from the site database 23 to the large language model, and generates site answer information according to the site question content.

The confidential information check unit 25 checks whether preset confidential information is included in the site answer information generated by the site processing unit 24. The confidential information is information that should not be included in the final answer information to the user. Specifically, the confidential information includes personal information of personnel engaged in the site, company confidential information, and the like.

In a case where the confidential information is included in the site answer information, the confidential information check unit 25 requests the site processing unit 24 to regenerate the site answer information not including the confidential information.

### Overall Configuration of Site Analysis Support Device

FIG. 3 is a diagram illustrating a hardware configuration of the upper-level analysis support device.

As illustrated in FIG. 3, the upper-level analysis support device 3A is a computer including hardware such as a CPU 71, a ROM 72, a RAM 73, a storage 74 such as a hard disk drive (HDD), and a communication module 75.

In the present example embodiment, a program of a large language model (LLM) is stored in the storage 74 of the upper-level analysis support device 3A. In the present example embodiment, no RAG program is stored in the storage 74 of the upper-level analysis support device 3A. This is because, in the present example embodiment, in generation of the final answer information to be executed by the upper-level analysis support device 3A, the site answer information from the plurality of site analysis support devices 2A may be integrated, and it is not necessary to directly search the upper-level database 33. Of course, the RAG program may be stored in the storage 74 of the upper-level analysis support device 3A.

By the CPU 71 of the upper-level analysis support device 3A executing a program stored in its own device in advance, as illustrated in FIG. 1, the upper-level analysis support device 3A functionally includes a transmission/reception unit 31, an upper-level database 33, and an upper-level processing unit 34.

The transmission/reception unit 31 can communicate with each of the user terminal 5 and the plurality of site analysis support devices 2A via a network. The transmission/reception unit 31 receives prompt information including a question content from the user terminal 5. The transmission/reception unit 31 can transmit the site prompt information generated by the upper-level processing unit 34 to each site analysis support device 2A via the network. The transmission/reception unit 31 can receive the site answer prompt information from each site analysis support device 2A. The transmission/reception unit 31 transmits the final answer information generated by the upper-level processing unit 34 to the user terminal 5.

The upper-level database 33 stores information necessary for generating the site prompt information. As the information necessary for generating the site prompt information, “attribute information” of the information accumulated in the site database 23 of each site analysis support device 2A and “application programming interface (API) endpoint” information as the address information of each site analysis support device 2A are exemplified. In the upper-level database 33, “API endpoint” information as address information of each site analysis support device 2A is stored in association with every “attribute information” of the information accumulated in the site database 23 of the plurality of site analysis support devices 2A. That is, information indicating in which site database 23 of which site what kind of “attribute information” is accumulated is stored in the upper-level database 33.

The upper-level processing unit 34 generates the site prompt information to be transmitted to the plurality of site analysis support devices 2A based on the question content included in the prompt information received from the user terminal 5 using the large language model. The generated site prompt information includes the site question content (question sentence) translated by the large language model so that each site analysis support device 2A can answer. Specifically, the upper-level processing unit 34 generates a sentence of the site question content as a clearer sentence from the question sentence from the user that may be input in colloquial form.

More specifically, the upper-level processing unit 34 includes the instruction information related to the site answer information generated by each of the plurality of site analysis support devices 2A in the site prompt information. Here, the instruction information includes, for example, at least one of attribute information (name) of information used when generating the site answer information, an analysis method for generating the site answer information, and an attribute of information included in the site answer information in the site processing unit 24 of each site.

The upper-level processing unit 34 extracts the site database 23 in which the attribute information related to the generated site question content is registered from the site database 23 of the site analysis support device 2A of the plurality of sites P1 to P3. In all the site analysis support devices 2A of the plurality of sites P1 to P3, not all the pieces of information of the plurality of pieces of “attribute information” as exemplified above are accumulated. For example, a certain sensor Sa may not be used in all sites and may be used only in some sites.

Therefore, in a case where the information regarding the sensor Sa is necessary in order to answer the site prompt information generated based on the question from the user, the upper-level processing unit 34 extracts the site in which the “attribute information” regarding the sensor Sa is stored.

The upper-level processing unit 34 transmits the generated site prompt information to the site analysis support device 2A of the extracted site among the site analysis support devices 2A of the plurality of sites.

In the site analysis support device 2A that has received such site prompt information, it is possible to generate the site answer information including the information of the designated “attribute” by the designated “analysis method” using the information of the “attribute information” designated by the instruction information among the large number of data accumulated in the site database 23.

Then, the upper-level processing unit 34 integrates the site answer information from the plurality of site analysis support devices 2A and generates final answer information for the question content from the user terminal 5. Here, in order to integrate the site answer information from the plurality of site analysis support devices 2A, calculation of the total number, calculation of the average value, and other various statistical methods can be appropriately used. The upper-level processing unit 34 transmits the generated final answer information to the user terminal 5 via the network.

### Procedure of Data Analysis Support Method

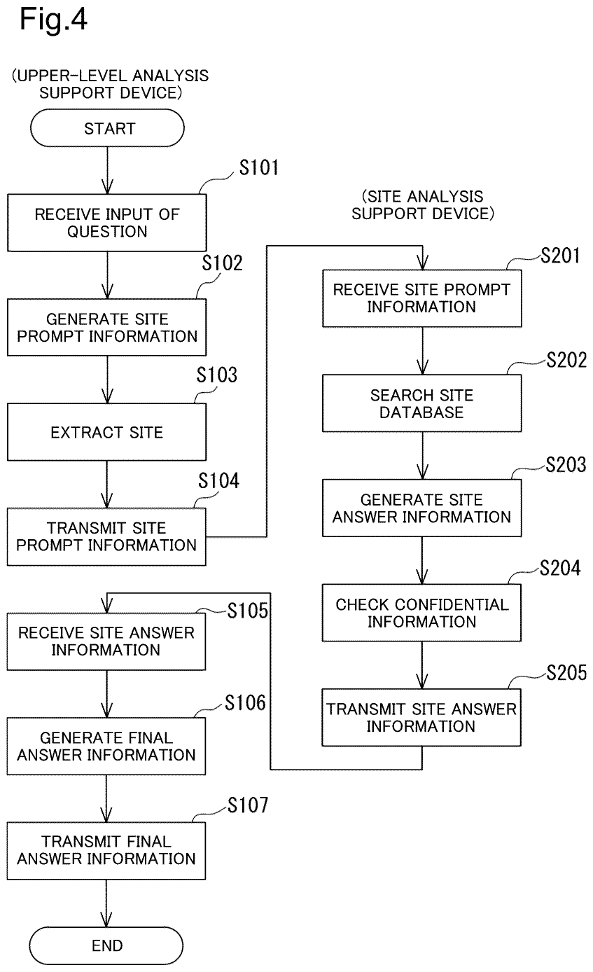

FIG. 4 is a flowchart illustrating a procedure of a data analysis support method according to the present disclosure.

As illustrated in FIG. 4, in the data analysis support system 1A, in a case where the user transmits prompt information including a question sentence (question content) using the user terminal 5, the upper-level analysis support device 3A receives the prompt information (step S101).

Next, the upper-level analysis support device 3A generates the site prompt information to be transmitted to the plurality of site analysis support devices 2A based on the question content included in the prompt information received from the user terminal 5 using the large language model (step S102). Here, the generated site prompt information is common among the site analysis support devices 2A of the plurality of sites P1 to P3.

Subsequently, the upper-level processing unit 34 extracts the site database 23 in which the attribute information related to the generated site question content is registered from the site database 23 of the site analysis support device 2A of the plurality of sites P1 to P3 (step S103).

In steps S102 to S103, in a case where it is determined that information for generating a valid answer to the question content from the user is not accumulated in the site database 23 of the site analysis support device 2A of the plurality of sites P1 to P3, the upper-level analysis support device 3A may notify the user terminal 5 that an answer is impossible at that time.

Next, the generated site prompt information is transmitted to the site analysis support device 2A of the extracted site among the site analysis support devices 2A of the plurality of sites P1 to P3 (step S104).

The site analysis support device 2A receives the site prompt information from the upper-level analysis support device 3A (step S201).

Next, in the site analysis support device 2A, the site processing unit 24 refers to the site database 23, and searches (acquires) the information including the “attribute information” included in the instruction information of the site prompt information received from the upper-level analysis support device 3A while using the large language model and the RAG (step S202).

Using the large language model, the site processing unit 24 generates the site answer information so as to include the information of the “attribute” included in the designation information using the information having the “attribute information” related to the site question content acquired from the site database 23 and the “analysis method” for generating the site answer information (step S203).

Next, the confidential information check unit 25 confirms whether the preset confidential information is included in the site answer information generated by the site processing unit 24 (step S204). In a case where the confidential information is included in the site answer information, the confidential information check unit 25 requests the site processing unit 24 to regenerate the site answer information not including the confidential information.

After checking the confidential information, the site analysis support device 2A transmits the generated site answer information to the upper-level analysis support device 3A (step S205).

The upper-level processing unit 34 receives the site answer information from the plurality of site analysis support devices 2A (step S105).

Thereafter, the upper-level processing unit 34 generates final answer information for the question content from the user terminal 5 based on the site answer information from the plurality of site analysis support devices 2A (step S106). Here, in order to integrate the site answer information from the plurality of site analysis support devices 2A, calculation of the total number, calculation of the average value, and other various statistical methods can be appropriately used.

The upper-level processing unit 34 transmits the generated final answer information to the user terminal 5 via the network (step S107). As a result, the user can obtain an answer to the question.

### Usage Example of Data Analysis Support System

In a case where the user inputs, for example, a question sentence “Please tell me the relationship between the attendance rate of employees of ○○ company and the weather” using the user terminal 5, the data analysis support system 1A as described above responds as follows, for example.

In the upper-level analysis support device 3A that has received the prompt information based on the question sentence as described above, in step S102, for example,
a question sentence “Please tell me the relationship between the attendance rate of employees and the weather. Please analyze the correlation based on the following conditions and tell me the results.” is generated as a question content of the site prompt information.

In the upper-level analysis support device 3A, for example, the following conditions 1) to 3) are included in the instruction information as the “analysis method”.
1) Use data for the past one month.
2) Analyze the relationship between the number of attendance days of each employee and the weather (sunny, rainy, cloudy, or the like).
3) Calculate the attendance rate under each weather condition.

In the upper-level analysis support device 3a, as the “attribute information” of the information used for analysis, for example,
employee information data: employee id, name, department, date and time (start), date and time (end).
weather data: date and weather are included in the instruction information.

The upper-level analysis support device 3A generates instruction information so as to provide the following information as the site answer information.
Average attendance rate for each weather condition (sunny, rainy, cloudy, or the like).
Correlation coefficient between the attendance rate and the weather.

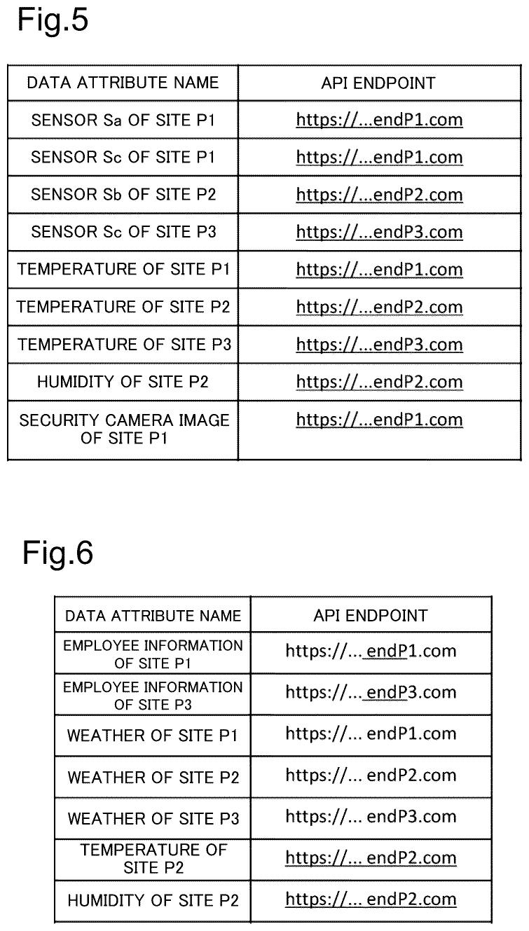

FIG. 5 is a diagram illustrating an example of the attribute information and the address information of the site analysis support device associated with the attribute information extracted from the information accumulated in the upper-level database.

In step S103, the upper-level analysis support device 3A refers to the upper-level database 33, and generates a list of the “attribute information” used for analysis included in the instruction information and the “API endpoint” which is the address information associated with the “attribute information” as illustrated in FIG. 5, for example. The upper-level analysis support device 3A extracts a site in which all the “attribute information” included in the instruction information and used for analysis exist in the site database 23 from the generated list as a transmission destination of the site prompt information. In the example of FIG. 5, “attribute information” of “employee information” and “weather” exists in the site P1 and the site P3. Therefore, the upper-level analysis support device 3A transmits the site prompt information to the site analysis support device 2A of the sites P1 and P3.

The site analysis support device 2A that has received the site prompt information analyzes the information of the site database 23 based on the instruction information, and as a result, for example, the following site answer information is generated.

### “Site P1:

Average attendance rate on sunny days: 25%
Average attendance rate on rainy days: 10%
Average attendance rate on cloudy days: 20%
Correlation coefficient between attendance rate and weather: 0.6”

### “Site P3:

Average attendance rate on sunny days: 30%
Average attendance rate on rainy days: 15%
Average attendance rate on cloudy days: 25%
Correlation coefficient between attendance rate and weather: 0.7”

In step S106, the upper-level analysis support device 3A that has obtained such site answer information integrates the site answer information from the site P1 and the site answer information from the site P3, and generates, for example, the following final answer information.
“Company-wide average attendance rate on sunny days: 27.5%
Company-wide average attendance rate on rainy days: 12.5%
Company-wide average attendance rate on cloudy days: 22.5%
Correlation coefficient between company-wide attendance rate and weather: 0.65”

### Usage Example of Data Analysis Support System

In a case where the user inputs, for example, a question sentence “Please compare the performances of the sensor Sa and the sensor Sb depending on the environment” with the user terminal 5, the data analysis support system 1A as described above responds as follows, for example.

In the upper-level analysis support device 3A that has received the prompt information based on the question sentence as described above, in step S102, for example,
a question sentence “Summarize the annual average performance indexes of the sensors Sa and Sb and the temperature information of the sites P1 and P2, and calculate and provide the information regarding the following items as appropriate.” is generated as a question content of the site prompt information.

In the upper-level analysis support device 3A, for example, the following purposes are included in the instruction information as the “analysis method”.

Purpose: To acquire basic information for performance comparison between the sensor Sa and the sensor Sb depending on the environment.

In the upper-level analysis support device 3A, as the “attribute information” of the information used for analysis, for example,
date and time, log, response time, and temperature (humidity) are included in the instruction information.

The upper-level analysis support device 3A generates instruction information so as to provide the following information as the site answer information.
Necessary information: failure rate, response time, accuracy, and temperature (humidity) for each month

• Output format: {
“Monthly_Performance”: [
{“Month”: “January”, “Failure_Rate”: xxx,
“Response_Time”: xxx, “Accuracy”: xxx,
“Temperature”: xxx, “Humidity”: xxx},
{“Month”: “February”, “Failure_Rate”: xxx,
...,
{“Month”: “December”, “Failure_Rate”: xxx,
“Response_Time”: xxx, “Accuracy”: xxx,
“Temperature”: xxx, “Humidity”: xx}

FIG. 6 is a diagram illustrating another example of the attribute information and the address information of the site analysis support device associated with the attribute information extracted from the information accumulated in the upper-level database.

In step S103, the upper-level analysis support device 3A refers to the upper-level database 33, and generates a list of the “attribute information” used for analysis included in the instruction information and the “API endpoint” which is the address information associated with the “attribute information” as illustrated in FIG. 6, for example. The upper-level analysis support device 3A extracts a site in which all the “attribute information” included in the instruction information and used for analysis exist in the site database 23 from the generated list as a transmission destination of the site prompt information. In the example of FIG. 6, “sensor Sa” and “sensor Sb” are used, and “attribute information” of “temperature” exists in the site P1 and the site P2 as the “environment”. Therefore, the upper-level analysis support device 3A transmits the site prompt information to the site analysis support device 2A of the sites P1 and P2.

The site analysis support device 2A that has received the site prompt information analyzes the information of the site database 23 based on the instruction information, and as a result, for example, the following site answer information is generated.

```
  “Site P1:
  { “Monthly_Performance”: [
  {“Month”: “January”, “Failure_Rate”: 0.02, “Response_Time”:
200, “Accuracy”:
  99.5, “Temperature”: 15},...,
  {“Month”: “December”, “Failure_Rate”: 0.01, “Response_Time”:
210, “Accuracy”: 99.5, “Temperature”: 10}
  ]}” “Site P3:
  { “Monthly_Performance”: [
  {“Month”: “January”, “Failure_Rate”: 0.03, “Response_Time”:
220, “Accuracy”:
  98.8, “Temperature”: −5, “Humidity”: 30},...,
  {“Month”: “December”, “Failure_Rate”: 0.02, “Response_Time”:
215, “Accuracy”: 99.0, “Temperature”: −3, “Humidity”: 32}
  ]}”
```

In step S106, the upper-level analysis support device 3A that has obtained such site answer information integrates the site answer information from the site P1 and the site answer information from the site P3, and generates the final answer information for, for example, comparison of the annual average performance indexes of the sensor Sa and the sensor Sb, environment-induced influence, suggestion, conclusion, and the like.

### Operational Effects

In the data analysis support system 1A, the upper-level analysis support device 3A, and the data analysis support method having the above-described configurations, the upper-level analysis support device 3A receives the prompt information including the question content from the user terminal 5, and the upper-level processing unit 34 generates the site prompt information including the site question content to which each of the plurality of site analysis support devices 2A can answer by the large language model based on the question content. In the site analysis support device 2A provided in each site, the site answer information according to the site question content included in the site prompt information received from the upper-level analysis support device 3A is generated by the large language model based on the information accumulated in the site database 23, and the generated site answer information is transmitted to the upper-level analysis support device 3A. The upper-level processing unit 34 integrates the site answer information from the plurality of site analysis support devices 2A, generates final answer information for the question content from the user terminal 5, and transmits the final answer information to the user terminal 5.

According to such a configuration, the data transmitted and received between the upper-level analysis support device 3A and the plurality of site analysis support devices 2A is the site prompt information and the site answer information. That is, the information itself accumulated in the site database 23 is not transmitted from the site analysis support device 2A to the upper-level analysis support device 3A. Therefore, it is easy to suppress an increase in the amount of data communication and to ensure data confidentiality.

### Second Example Embodiment

Next, a second example embodiment of a data analysis support system according to the present disclosure will be described. In the second example embodiment described below, the same reference signs are given to common configurations to those of the first example embodiment in the drawings, and the description thereof will be omitted.

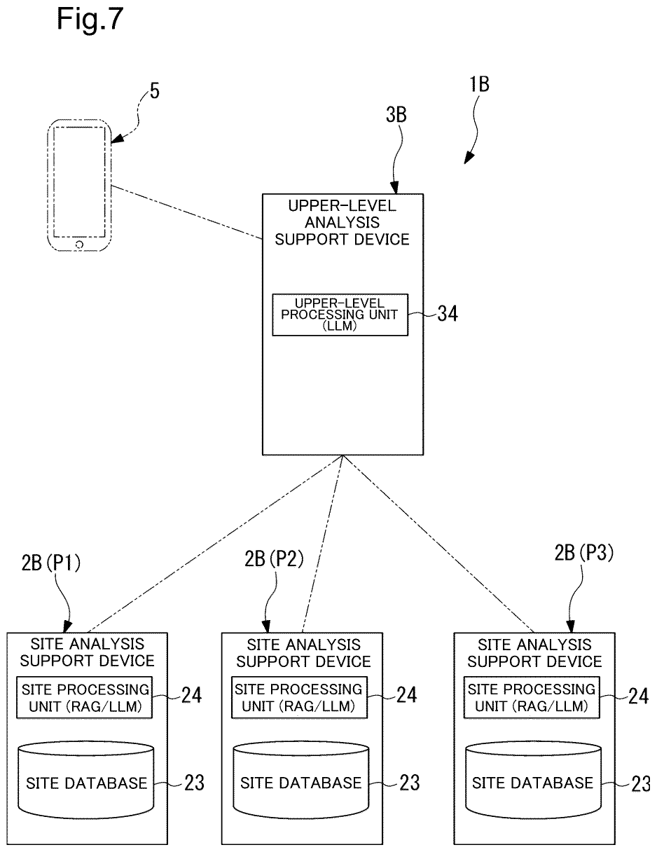

FIG. 7 is a diagram illustrating a configuration of the data analysis support system according to the present disclosure.

As illustrated in FIG. 7, a data analysis support system 1B includes a site analysis support device 2B installed for each of the plurality of sites P1 to P3 and an upper-level analysis support device 3B communicable with each of the plurality of site analysis support devices 2B.

The upper-level analysis support device 3B includes an upper-level processing unit 34. The upper-level processing unit 34 receives prompt information including question contents from the user terminal 5. The upper-level processing unit 34 generates the site prompt information including the site question content that can be answered by each of the plurality of site analysis support devices 2B by the large language model based on the question content. The upper-level processing unit 34 transmits the generated site prompt information to the site analysis support device 2B.

The site analysis support device 2B includes a site database 23 in which information regarding the site is accumulated and a site processing unit 24.

The site processing unit 24 generates site answer information according to the site question content included in the received site prompt information by the large language model based on the information accumulated in the site database 23. The site processing unit 24 transmits the generated site answer information to the upper-level analysis support device 3B.

The upper-level processing unit 34 integrates the site answer information from the plurality of site analysis support devices 2B, generates final answer information for the question content from the user terminal 5, and transmits the final answer information to the user terminal 5.

According to the data analysis support system 1B as described above, it is easy to suppress an increase in the amount of data communication and to ensure data confidentiality.

### Third Example Embodiment

Next, a third example embodiment of an analysis support device according to the present disclosure will be described. In the third example embodiment described below, the same reference signs are given to the configurations common to the first example embodiment and the second example embodiment in the drawings, and the description thereof is omitted.

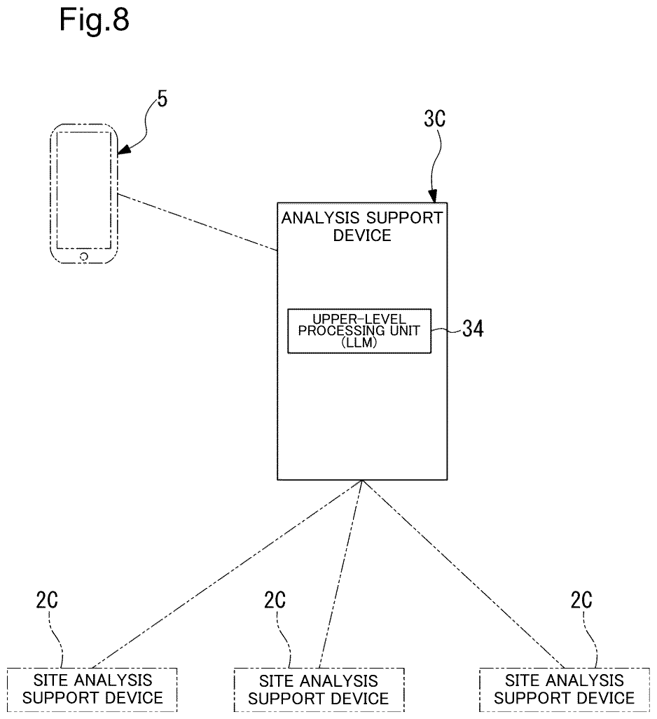

FIG. 8 is a diagram illustrating a configuration of an analysis support device according to the present disclosure.

As illustrated in FIG. 8, the analysis support device 3C can communicate with each of the site analysis support devices 2C installed in each of the plurality of sites P1 to P3.

The analysis support device 3C includes an upper-level processing unit 34. The upper-level processing unit 34 receives prompt information including question contents from the user terminal 5. The upper-level processing unit 34 generates the site prompt information including the site question content that can be answered by each of the plurality of site analysis support devices 2C by the large language model based on the question content. The upper-level processing unit 34 transmits the generated site prompt information to the site analysis support device 2C. The upper-level processing unit 34 integrates the site answer information generated according to the site question content by the plurality of site analysis support devices 2C. The upper-level processing unit 34 generates final answer information for the question content from the user terminal 5 and transmits the final answer information to the user terminal 5.

According to the analysis support device 3C as described above, it is easy to suppress an increase in the amount of data communication and to ensure data confidentiality.

### Fourth Example Embodiment

Next, a fourth example embodiment of a data analysis support method according to the present disclosure will be described. In the fourth example embodiment described below, the same reference signs are given to the configurations common to the first to third example embodiments in the drawings, and the description thereof is omitted.

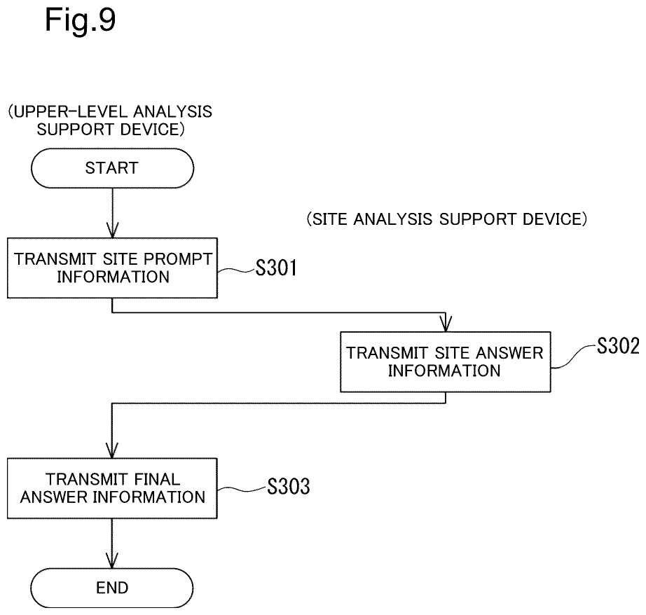

FIG. 9 is a diagram illustrating a procedure of a data analysis support method according to the present disclosure.

As illustrated in FIG. 9, the data analysis support method is a data analysis support method in a data analysis support system including a plurality of site analysis support devices, each installed at one of a plurality of sites and an upper-level analysis support device communicable with each of the plurality of site analysis support devices.

The data analysis support method includes step S301 of transmitting the site prompt information, step S302 of transmitting the site answer information, and step S303 of transmitting the final answer information.

In step S301 of transmitting the site prompt information, the upper-level analysis support device receives the prompt information including the question content from the user terminal. In step S301, the site prompt information including the site question content that can be answered by each of the plurality of site analysis support devices is generated by the large language model based on the question content. In step S301, the generated site prompt information is transmitted to the site analysis support device.

In step S302 of transmitting the site answer information, the site analysis support device generates the site answer information according to the site question content included in the received site prompt information by the large language model based on the information accumulated in the site database 23. In step S302, the generated site answer information is transmitted to the upper-level analysis support device.

In step S303 of transmitting the final answer information, the upper-level analysis support device integrates the site answer information from the plurality of site analysis support devices. In step S303, final answer information for the question content from the user terminal is generated and transmitted to the user terminal.

According to the data analysis support method as described above, it is easy to suppress an increase in the amount of data communication and to ensure data confidentiality.

### Fifth Example Embodiment

Next, a fifth example embodiment of a data analysis support method according to the present disclosure will be described. In the fifth example embodiment described below, the same reference signs are given to the configurations common to the first to fourth example embodiments in the drawings, and the description thereof is omitted.

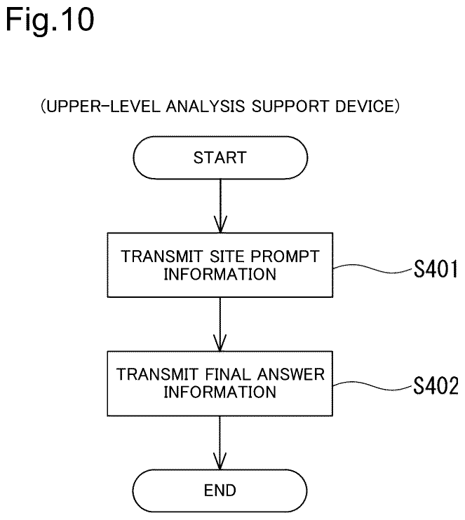

FIG. 10 is a diagram illustrating a procedure of a data analysis support method according to the present disclosure.

As illustrated in FIG. 10, the data analysis support method is a data analysis support method in an analysis support device that can communicate with each of site analysis support devices installed in each of a plurality of sites.

The data analysis support method includes step S401 of transmitting the site prompt information and step S402 of transmitting the final answer information.

In step S401 of transmitting the site prompt information, the prompt information including the question content from the user terminal is received. In step S401, the site prompt information including the site question content that can be answered by each of the plurality of site analysis support devices is generated by the large language model based on the question content. In step S401, the generated site prompt information is transmitted to the site analysis support device.

In step S402 of transmitting the final answer information, the site answer information generated according to the site question content by the plurality of site analysis support devices is integrated. In step S402, final answer information for the question content from the user terminal is generated and transmitted to the user terminal.

According to the data analysis support method as described above, it is easy to suppress an increase in the amount of data communication and to ensure data confidentiality.

### Other Example Embodiments

Although the example embodiments of the present disclosure have been described in detail with reference to the drawings, the specific configuration is not limited to these example embodiments, and includes design changes and the like without departing from the gist of the present disclosure.

In the above example embodiments, specific use examples of the data analysis support system 1A have been described, but the installation location, the data to be accumulated, the purpose of use of the analyzed data, and the like are not limited at all.

A program for implementing all or some of the functions of the upper-level analysis support device 3A (analysis support device) and the site analysis support device 2A may be recorded in a computer-readable recording medium, and the program recorded in the recording medium may be read and executed by a computer system to perform processing by each functional unit. The “computer system” here includes hardware such as an OS and peripheral apparatuses. The “computer system” is assumed to include a home page provision environment (or display environment) in a case where the WWW system is used. The “computer-readable recording medium” refers to a portable medium such as a CD, a DVD, or a USB, or a storage device such as a hard disk built in a computer system. In a case where this program is distributed to the upper-level analysis support device 3A and the site analysis support device 2A through a communication line, the upper-level analysis support device 3A and the site analysis support device 2A that have received the distribution may deploy the program in the storage 64 and execute the above processing. The program may be for implementing a part of the functions described above, and the functions described above may be achieved in combination with a program already recorded in the computer system.

JP 7506957 B2 discloses a configuration that receives a prompt from a user and obtains an output by a large language model (LLM) for the prompt.

Meanwhile, there are cases where a prompt from a user is received and, by a large language model, an answer to the prompt is generated based on data stored in a database.

In such a case, the computer having the large language model stored therein acquires data stored in the database and generates an answer based on the acquired data.

However, in a case where the amount of data acquired from the database is enormous or in a case where data is acquired from a plurality of databases in order to generate an answer, the amount of data communication between the database and the computer increases. In a case where the data stored in the database includes confidential information, it is necessary to ensure data confidentiality in a case where the data is transmitted from the database to the computer in which the large language model is stored.

The present disclosure has been made to solve the above problems, and an object of the present disclosure is to provide a data analysis support system, an analysis support device, a data analysis support method, and a program that easily suppress an increase in the amount of data communication and ensure data confidentiality.

According to the present disclosure, it is easy to suppress an increase in the amount of data communication and to secure data confidentiality.

### SUPPLEMENTARY NOTE

Some or all of the above-described example embodiments may be described as the following Supplementary Notes, but are not limited to the following.

### Supplementary Note 1

A data analysis support system including:
a plurality of site analysis support devices, each installed at one of a plurality of sites; and
an upper-level analysis support device communicable with each of a plurality of the site analysis support devices, wherein
the upper-level analysis support device includes:
an upper-level processing unit that receives prompt information including question content from a user terminal, generates site prompt information including site question content that allows each of the plurality of the site analysis support devices to answer based on the question content by using a large language model, and transmits the site prompt information generated to the site analysis support device,
the site analysis support device includes:
a site database in which information regarding the corresponding site is accumulated; and
a site processing unit that generates site answer information according to the site question content included in the site prompt information received, by using a large language model based on information accumulated in the site database, and transmits the site answer information generated to the upper-level analysis support device, and
the upper-level processing unit integrates site answer information from the plurality of the site analysis support devices, generates final answer information for the question content from the user terminal, and transmits the final answer information to the user terminal.

### Supplementary Note 2

The data analysis support system according to Supplementary Note 1, wherein
the upper-level analysis support device further includes:
an upper-level database in which attribute information related to information accumulated in each site database of the plurality of the site analysis support devices is registered, and
the upper-level processing unit extracts the site database in which the attribute information related to the site question content is registered, and transmits the site prompt information to the site analysis support device including the site database extracted among the plurality of the site analysis support devices.

### Supplementary Note 3

The data analysis support system according to Supplementary Note 2, wherein the attribute information and address information of the plurality
of the site analysis support devices are registered in the upper-level database in association with each other.

### Supplementary Note 4

The data analysis support system according to Supplementary Note 1 or 2, wherein
the upper-level processing unit generates the site prompt information including instruction information regarding the site answer information generated by each of the plurality of the site analysis support devices, and
the site processing unit generates the site answer information based on the instruction information.

### Supplementary Note 5

The data analysis support system according to Supplementary Note 4, wherein
the instruction information includes at least one of the attribute information of information used when generating the site answer information for the question content, an analysis method for generating the site answer information, and an attribute of information included in the site answer information.

### Supplementary Note 6

The data analysis support system according to Supplementary Note 1 or 2, wherein
the site analysis support device further includes:
a confidential information check unit that checks whether the site answer information generated includes confidential information.

### Supplementary Note 7

An analysis support device communicable with each site analysis support device installed in each of a plurality of sites, the analysis support device including
an upper-level processing unit that receives prompt information including question content from a user terminal, generates site prompt information including site question content that allows each of a plurality of the site analysis support devices to answer based on the question content by using a large language model, and transmits the site prompt information generated to the site analysis support device, wherein
the upper-level processing unit integrates site answer information generated according to the site question content by the plurality of the site analysis support devices, generates final answer information for the question content from the user terminal, and transmits the final answer information to the user terminal.

### Supplementary Note 8

The analysis support device according to Supplementary Note 7, further including:
an upper-level database in which attribute information related to information accumulated in each site database of the plurality of the site analysis support devices is registered, wherein
the upper-level processing unit extracts the site database in which the attribute information related to the site question content is registered, and transmits the site prompt information to the site analysis support device including the site database extracted among the plurality of the site analysis support devices.

### Supplementary Note 9

The analysis support device according to Supplementary Note 8, wherein
the attribute information and address information of the plurality of the site analysis support devices are registered in the upper-level database in association with each other.

### Supplementary Note 10

A data analysis support method in a data analysis support system including:
a plurality of site analysis support devices, each installed at one of a plurality of sites; and
an upper-level analysis support device communicable with each of a plurality of the site analysis support devices, the data analysis support method including:
a step of receiving, by the upper-level analysis support device, prompt information including question content from a user terminal, generating site prompt information including site question content that allows each of the plurality of the site analysis support devices to answer based on the question content by using a large language model, and transmitting the site prompt information generated to the site analysis support device;
a step of generating, by the site analysis support device, site answer information according to the site question content included in the site prompt information received, by using a large language model based on information accumulated in a site database, and transmitting the site answer information generated to the upper-level analysis support device; and
a step of integrating, by the upper-level analysis support device, site answer information from the plurality of the site analysis support devices, generating final answer information for the question content from the user terminal, and transmitting the final answer information to the user terminal.

### Supplementary Note 11

A data analysis support method in an analysis support device communicable with each site analysis support device installed in each of a plurality of sites, the data analysis support method including:
a step of receiving prompt information including question content from a user terminal, generating site prompt information including site question content that allows each of a plurality of the site analysis support devices to answer based on the question content by using a large language model, and transmitting the site prompt information generated to the site analysis support device; and
a step of integrating site answer information generated according to the site question content by the plurality of the site analysis support devices, generating final answer information for the question content from the user terminal, and transmitting the final answer information to the user terminal.

### Supplementary Note 12

A non-transitory recording medium storing a program for causing an analysis support device communicable with each site analysis support device installed in each of a plurality of sites to execute processing of:
a step of receiving prompt information including question content from a user terminal, generating site prompt information including site question content that allows each of a plurality of the site analysis support devices to answer based on the question content by using a large language model, and transmitting the site prompt information generated to the site analysis support device; and
a step of integrating site answer information generated according to the site question content by the plurality of the site analysis support devices, generating final answer information for the question content from the user terminal, and transmitting the final answer information to the user terminal.

Some or all of the configurations described in Supplementary Notes 2 to 6 dependent on the above-described Supplementary Note 1 can also depend on Supplementary Note 10 and Supplementary Note 12 by the same dependency relationship as Supplementary Notes 2 to 6. Furthermore, some or all of the configurations described as the Supplementary Notes can be similarly dependent on not only the Supplementary Notes 1, 10, and 12, but also various pieces of hardware and software, and various recording means or systems for recording software without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A data analysis support system comprising:
a plurality of site analysis support devices, each installed at one of a plurality of sites; and
an upper-level analysis support device communicable with each of the site analysis support devices, wherein
the upper-level analysis support device comprises:
at least one memory storing instructions; and
at least one processor configured to access the at least one memory and execute the instructions to:
receive prompt information including question content from a user terminal;
generate site prompt information including site question content that allows each of the plurality of the site analysis support devices to answer based on the question content by using a large language model; and
transmit the site prompt information generated to at least one of the site analysis support devices, and
each of the site analysis support devices comprises:
a site database in which information regarding the corresponding site is accumulated;
at least one memory storing instructions; and
at least one processor configured to access the at least one memory and execute the instructions to:
generate site answer information according to the site question content included in the site prompt information received, by using a large language model based on information accumulated in the site database; and
transmit the site answer information generated to the upper-level analysis support device, wherein
the at least one processor of the upper-level analysis support device is further configured to execute the instructions to:
integrate site answer information from at least one of the site analysis support devices;
generate final answer information for the question content from the user terminal; and
transmit the final answer information to the user terminal.

2. The data analysis support system according to claim 1, wherein
the upper-level analysis support device further comprises:
an upper-level database in which attribute information related to information accumulated in each site database of the plurality of the site analysis support devices is registered, and
the at least one processor of the upper-level analysis support device is further configured to execute the instructions to:
extract the site database in which the attribute information related to the site question content is registered; and
transmit the site prompt information to at least one of the site analysis support devices comprising the site database extracted among the plurality of the site analysis support devices.

3. The data analysis support system according to claim 2, wherein
the attribute information and address information of the plurality of the site analysis support devices are registered in the upper-level database in association with each other.

4. The data analysis support system according to claim 1, wherein
the at least one processor of the upper-level analysis support device is further configured to execute the instructions to:
generate the site prompt information including instruction information regarding the site answer information generated by each of the site analysis support devices, and
the at least one processor of each of the site analysis support devices is further configured to execute the instructions to:
generate the site answer information based on the instruction information.

5. The data analysis support system according to claim 4, wherein
the instruction information includes at least one of information used when generating the site answer information for the question content, an analysis method for generating the site answer information, and an attribute of information included in the site answer information.

6. The data analysis support system according to claim 1, wherein
the at least one processor of each of the site analysis support devices is further configured to execute the instructions to:
check whether the site answer information generated includes confidential information.

7. An analysis support device communicable with each site analysis support device installed in each of a plurality of sites, the analysis support device comprising:
at least one memory storing instructions; and
at least one processor configured to access the at least one memory and execute the instructions to:
receive prompt information including question content from a user terminal;
generate site prompt information including site question content that allows each of the site analysis support devices to answer based on the question content by using a large language model; and
transmit the site prompt information generated to at least one of the site analysis support devices;
integrate site answer information generated according to the site question content by at least one of the site analysis support devices;
generate final answer information for the question content from the user terminal; and
transmit the final answer information to the user terminal.

8. The analysis support device according to claim 7, further comprising:
an upper-level database in which attribute information related to information accumulated in each site database of the plurality of the site analysis support devices is registered, wherein
the at least one processor is further configured to execute the instructions to:
extract the site database in which the attribute information related to the site question content is registered; and
transmit the site prompt information to at least one of the site analysis support devices comprising the site database extracted among the plurality of the site analysis support devices.

9. The analysis support device according to claim 8, wherein
the attribute information and address information of the plurality of the site analysis support devices are registered in the upper-level database in association with each other.

10. The analysis support device according to claim 8, wherein
the at least one processor is further configured to execute the instructions to:
generate the site prompt information including instruction information regarding the site answer information generated by each of the site analysis support devices.

11. The analysis support device according to claim 10, wherein
the instruction information includes at least one of information used when generating the site answer information for the question content, an analysis method for generating the site answer information, and an attribute of information included in the site answer information.

12. A data analysis support method in a data analysis support system including:
a plurality of site analysis support devices, each installed at one of a plurality of sites; and
an upper-level analysis support device communicable with each of the site analysis support devices, the data analysis support method comprising:
receiving, by the upper-level analysis support device, prompt information including question content from a user terminal, generating site prompt information including site question content that allows each of the plurality of the site analysis support devices to answer based on the question content by using a large language model, and transmitting the site prompt information generated to at least one of the site analysis support devices;
generating, by each site analysis support device that received the site prompt information, site answer information according to the site question content included in the site prompt information received, by using a large language model based on information accumulated in a site database, and transmitting the site answer information generated to the upper-level analysis support device; and
integrating, by the upper-level analysis support device, site answer information from the at least one of the site analysis support devices, generating final answer information for the question content from the user terminal, and transmitting the final answer information to the user terminal.
